(19) United States
(12) Patent Application Publication
(10) Pub. No.: US 2020/0029016 A1
(43) Pub. Date: Jan. 23, 2020

(54) MOVING OBJECT MONITORING DEVICE AND MOVING OBJECT MONITORING SYSTEM

(71) Applicant: PANASONIC INTELLECTUAL PROPERTY MANAGEMENT CO., LTD., Osaka (JP)

(72) Inventors: Shogo TANAKA, Kanagawa (JP); Kenji TABEI, Kanagawa (JP)

(73) Assignee: PANASONIC INTELLECTUAL PROPERTY MANAGEMENT CO., LTD., Osaka (JP)

(21) Appl. No.: 16/483,571

(22) PCT Filed: Dec. 19, 2017
(86) PCT No.: PCT/JP2017/045413

§ 371 Date: Aug. 5, 2019

(30) Foreign Application Priority Data
Feb. 8, 2017 (JP) 2017-021379

(51) Int. Cl. H04N 5/232; H04N 5/225; H04N 7/18; H04N 9/73

(52) U.S. Cl. CPC H04N 5/23235; H04N 9/735; H04N 7/18; H04N 5/2258

(57) ABSTRACT

The present application is provided with: a color camera that captures a monitoring area using environmental light, a monochrome camera that captures the monitoring area using infrared light, and a signal processor that processes a signal of a color image output from the color camera and a signal of a monochrome image output from the monochrome camera, in which the signal processor includes: a resolution converter that reduces the number of pixels in the color image by adding a signal value of each of a plurality of adjacent pixels in the color image, a signal level detector that detects the signal level of the color image, and a signal processing controller that controls an operation of the resolution converter based on the signal level.

### TECHNICAL FIELD

The present disclosure relates to a moving object monitoring device that outputs an image obtained by capturing a monitoring area where a moving object to be monitored appears and a moving object monitoring system that transmits the image obtained by capturing the monitoring area from the moving object monitoring device to an image storage device through a network.

### BACKGROUND ART

A monitoring system for monitoring the status of a moving object such as a person to be monitored by installing a camera for capturing a monitoring area is widely used. In order for such a monitoring system to be able to continue monitoring even at night, a camera may be used, which irradiates a subject with infrared light and captures the subject.

While such capturing by the infrared light may provide a clear image, because the image is a monochrome image, the color of the subject may not be discriminated. In particular, since the image is captured in a state where the luminance is inverted, the blue clothes of a person are shown in white, for example, resulting in a problem of occurrence of false recognition of the moving subject to be monitored. Therefore, there is a need for a technology that enables discrimination of the color of the subject even in an image captured at night.

In response to such a demand, there is known a technique that captures a subject with infrared light, and then irradiates the subject with visible laser light corresponding to the three primary colors in a predetermined projection pattern so that color information of the subject is acquired based on the intensity of the reflected light of each color, and colors the infrared image using the color information (see PTL 1).

### CITATION LIST

### Patent Literature

PTL 1: Japanese Patent Unexamined Publication No. 2013-219560

### SUMMARY OF THE INVENTION

However, in this prior art, although an image that enables discrimination of the color of the subject may be obtained, it is necessary to use an expensive laser light source to irradiate the laser light, thus resulting in a problem that the manufacturing cost of the device increases.

Therefore, an objective of the present disclosure is to provide a moving object monitoring device and a moving object monitoring system capable of outputting, with a low-cost configuration, a suitable color image in which the actual colors of the subject are clearly expressed in accordance with a status of environmental light.

The moving object monitoring device according to the present disclosure relates to a moving object monitoring device that outputs a color image and a monochrome image obtained by capturing a monitoring area where a moving object to be monitored appears, in which the moving object monitoring device includes a color camera that captures the monitoring area using environmental light, a monochrome camera that captures the monitoring area using infrared light, and a signal processor that processes a signal of a color image output from the color camera and a signal of a monochrome image output from the monochrome camera, in which the signal processor includes: a resolution converter that reduces the number of pixels in the color image by adding a signal value of each of a plurality of adjacent pixels in the color image, and a signal processing controller that controls an operation of the resolution converter based on a capturing environment of the monitoring area.

In addition, the moving object monitoring system according to the present disclosure transmits a color image and a monochrome image obtained by capturing, at a moving object monitoring device, a monitoring area where a moving object to be monitored appears, from the moving object monitoring device to an image storage device through a network, in which the moving object monitoring device includes a color camera that captures a monitoring area using environmental light, a monochrome camera that captures the monitoring area using infrared light, a signal processor that processes a signal of a color image output from the color camera and a signal of a monochrome image output from the monochrome camera, and a communication unit that transmits the color image and the monochrome image processed by the signal processor to the image storage device, in which the signal processor includes a resolution converter that reduces a number of pixels in the color image by adding a signal value of each of a plurality of adjacent pixels in the color image, and a signal processing controller that controls an operation of the resolution converter based on a capturing environment of the monitoring area.

According to the present disclosure, in a status in which there is slight environmental light, the actual color information of the subject is included in the signal value of each pixel, and therefore it is possible to output a color image in which the actual colors of the subject are clearly expressed, by adding the signal values of a plurality of pixels. In addition, since the operation of the resolution converter is controlled based on the signal level, that is, the brightness of the environmental light, a suitable color image may be output regardless of the status of the environmental light. In addition, because expensive parts such as a laser light source are unnecessary, the manufacturing cost can be reduced.

### BRIEF DESCRIPTION OF DRAWINGS

FIG. 1 is an overall configuration diagram of a moving object monitoring system according to an exemplary embodiment.

FIG. 2 is an explanatory view showing a capturing status by camera device 1.

FIG. 3 is a block diagram showing a schematic configuration of camera device 1.

FIG. 4 is a functional block diagram showing a schematic configuration of signal processor 21.

FIG. 5 is an explanatory view showing an outline of a resolution conversion performed by resolution converter 54.

FIG. 6A is an explanatory view showing a histogram before the resolution conversion.

FIG. 6B is an explanatory view showing a histogram after the resolution conversion.

FIG. 7 is an explanatory view showing a processing mode set by signal processing controller 53.

FIG. 8 is a flowchart showing a procedure of processing performed by signal processing controller 53.

FIG. 9 is a flowchart showing a procedure of white balance correction performed by gradation color tone correction unit 55.

FIG. 10A is an explanatory view showing a status of gradation correction performed by gradation color tone correction unit 55.

FIG. 10B is an explanatory view showing a status of the gradation correction performed by gradation color tone correction unit 55.

FIG. 10C is an explanatory view showing a status of the gradation correction performed by gradation color tone correction unit 55.

FIG. 10D is an explanatory view showing a status of the gradation correction performed by gradation color tone correction unit 55.

### DESCRIPTION OF EMBODIMENT

According to a first aspect of the present invention, there is provided a moving object monitoring device that outputs a color image and a monochrome image obtained by capturing a monitoring area where a moving object to be monitored appears, in which the moving object monitoring device includes: a color camera that captures a monitoring area using environmental light, a monochrome camera that captures the monitoring area using infrared light, and a signal processor that processes a signal of a color image output from the color camera and a signal of a monochrome image output from the monochrome camera, in which the signal processor includes: a resolution converter that reduces the number of pixels in the color image by adding a signal value of each of a plurality of adjacent pixels in the color image, and a signal processing controller that controls an operation of the resolution converter based on a capturing environment of the monitoring area.

With this configuration, in a status in which there is slight environmental light, the actual color information of the subject is included in the signal value of each pixel, and therefore it is possible to output a color image in which the actual colors of the subject are clearly expressed, by adding the signal values of a plurality of pixels. In addition, since the operation of the resolution converter is controlled based on the signal level, that is, the brightness of the environmental light, a suitable color image may be output regardless of the status of the environmental light. In addition, because expensive parts such as a laser light source are unnecessary, the manufacturing cost can be reduced.

In a second aspect of the present invention, a signal level detector that detects a signal level of a color image is provided, and the signal level is referred to for determination of a capturing environment.

With this configuration, a suitable resolution conversion may be performed according to the signal level of the color image.

In a third aspect of the present invention, the signal processing controller stops the operation of the resolution converter when the signal level is determined to be equal to or greater than a predetermined threshold value.

With this configuration, in a state where the signal level is sufficiently high, that is, there is sufficient environmental light, because this is a case when there is no need to perform the resolution conversion, the resolution conversion is not necessarily performed, thereby avoiding unnecessary processing.

In a fourth aspect of the present invention, the signal processing controller compares the signal level with a plurality of threshold values, and changes a degree of resolution conversion at the resolution converter stepwise based on the comparison result.

With this configuration, the degree of resolution conversion is changed according to the signal level, that is, the brightness of the environmental light, so that saturation of the signal value may be suppressed, and a suitable color image may be output.

In a fifth aspect of the present invention, there is further provided an averaging reduction unit that performs reduction processing by averaging on the color image signals output from the resolution converter, in which the signal processing controller sets the degree of averaging reduction at the averaging reduction unit to obtain a color image of the same size according to the degree of resolution conversion at the resolution converter.

With this configuration, it is possible to output a color image of uniform size regardless of the degree of resolution conversion.

In addition, according to a sixth aspect of the present invention, there is provided a moving object monitoring system that transmits a color image and a monochrome image obtained by capturing, at a moving object monitoring device, a monitoring area where a moving object to be monitored appears from the moving object monitoring device to the image storage device through a network, in which the moving object monitoring device includes: a color camera that captures a monitoring area using environmental light; a monochrome camera that captures the monitoring area using infrared light; a signal processor that processes a signal of a color image output from the color camera and a signal of a monochrome image output from the monochrome camera; and a communication unit that transmits the color image and the monochrome image processed by the signal processor to the image storage device, in which the signal processor includes: a resolution converter that reduces the number of pixels in the color image by adding a signal value of each of a plurality of adjacent pixels in the color image; and a signal processing controller that controls an operation of the resolution converter based on a capturing environment of the monitoring area.

With this configuration, as in the first aspect of the invention, it is possible to output, with a low-cost configuration, a suitable color image in which the actual colors of the subject are clearly expressed in accordance with the status of the environmental light.

In a seventh aspect of the present invention, the communication unit adds capturing information including at least one of an installation place, a camera attribute, a capturing time, and a capturing condition to a color image and a monochrome image and transmits the same.

With this configuration, management of color images and monochrome images performed in the image storage device is facilitated, and capturing information may be presented to a user who browses the images.

Hereinafter, embodiments will be described with reference to the drawings.

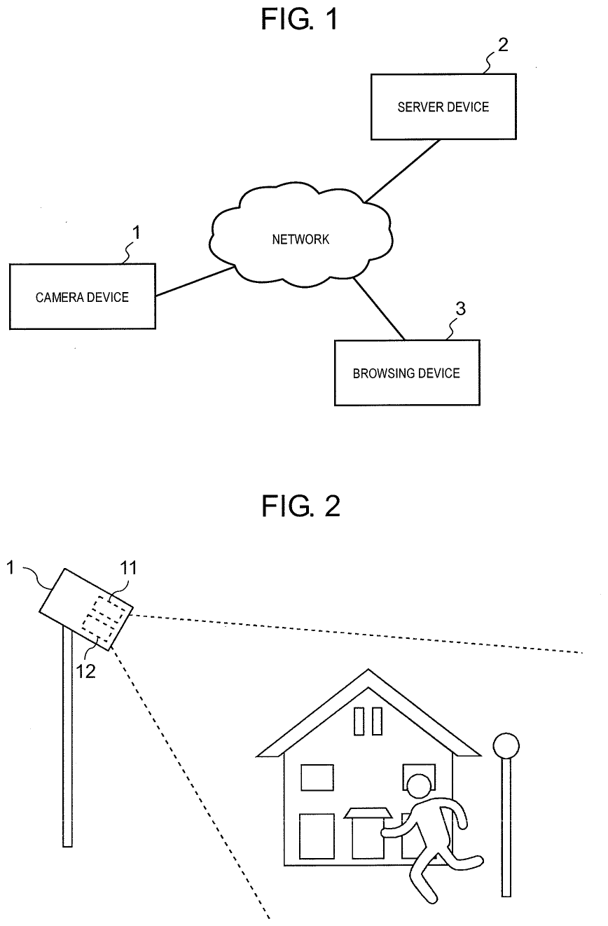

FIG. 1 is an overall configuration diagram of the moving object monitoring system according to the exemplary embodiment.

The moving object monitoring system includes camera device 1 (moving object monitoring device), server device 2 (image storage device), and browsing device 3. Camera device 1, server device 2, and browsing device 3 are connected through a network.

Camera device 1 captures an image of a monitoring area set in a facility, a road, and the like, and outputs a captured image in which a moving object such as a person present in the monitoring area is shown. Server device 2 stores the captured images acquired from camera device 1. Browsing device 3 is a PC, a tablet terminal, a smartphone, and the like, and the user may access server device 2 to browse the captured image stored in server device 2.

Next, camera device 1 will be described. FIG. 2 is an explanatory view showing the capturing status with respect to camera device 1.

Camera device 1 includes color camera 11 and monochrome camera 12. Color camera 11 and monochrome camera 12 capture a subject present in the monitoring area, that is, a moving object such as a person, a building, a site of a facility, a road, and the like.

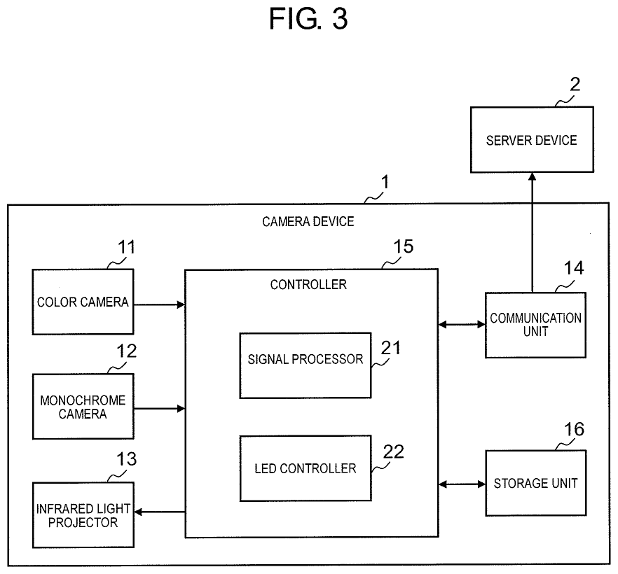

Color camera 11 includes an infrared light cut filter, captures a subject in color using visible light, and outputs a color image. Monochrome camera 12 includes a visible light cut filter, captures a subject in monochrome with infrared light, and outputs a monochrome image. When capturing with monochrome camera 12, infrared light projector 13 irradiates the subject with near infrared light (see FIG. 3).

Here, when capturing is performed with color camera 11 in a state of insufficient environmental light at night, in a sunset or sunrise time zone, there is a problem that, in a captured color image, a moving object as a subject or a background appears dark, such that it is difficult to discriminate the color of the moving object, for example, the color of clothes of a person or the color of a vehicle object. In addition, in a monochrome image captured using near infrared light by monochrome camera 12, there is a problem that the image is captured in a state in which the luminance is inverted such that, for example, blue clothes of a person are shown in white. Therefore, false recognition of the moving object occurs.

Therefore, in the exemplary embodiment, by performing signal processing on the signal color image output from color camera 11, even when the image is captured in a state of insufficient environmental light, it is possible to generate a high-quality color image in which the actual colors of the subject are clearly expressed.

In the exemplary embodiment, while color camera 11 and monochrome camera 12 are provided, there may also be provided one so-called day-and-night camera capable of switching the capturing mode between the day and the night. This day-and-night camera may switch between a mode for capturing a color image using visible light and a mode for capturing a monochrome image using infrared light with insertion of an infrared light cut filter thereto and removal of the infrared light cut filter therefrom, for example.

Moreover, an example in which the outdoors is a monitoring area is shown in FIG. 2, but the indoors may also be a monitoring area. In this case, in addition to sunshine, the brightness of the environmental light of the monitoring area is changed according to on/off of lighting equipment.

Next, a schematic configuration of camera device 1 will be described.

FIG. 3 is a block diagram showing a schematic configuration of camera device 1.

Camera device 1 includes infrared light projector 13, communication unit 14, controller 15, and storage unit 16 in addition to color camera 11 and monochrome camera 12.

Infrared light projector 13 projects near infrared light onto the subject when the subject is captured by monochrome camera 12.

Communication unit 14 communicates with server device 2 through a network. In the exemplary embodiment, the processed color image and monochrome image output from controller 15 are transmitted to server device 2.

At this time, capturing information regarding an installation location, a camera attribute, a capturing time, a capturing condition and the like is added to the color image and monochrome image as attribute information and transmitted. The camera attribute relates to whether color or monochrome, identification information of camera device 1 (such as a MAC address), and the like. The capturing condition relates to the exposure time, the gain, and the like.

Text recognition processing may be performed on the monochrome image to acquire text information in the monochrome image, and the text information may be added to the monochrome image.

Storage unit 16 stores color images and monochrome images generated by controller 15. Storage unit 16 also stores a program executed by controller 15.

Controller 15 includes signal processor 21 and LED controller 22. Controller 15 is configured by a processor, and each unit of controller 15 is realized by executing a program stored in storage unit 16.

Signal processor 21 processes image signals respectively output from color camera 11 and monochrome camera 12.

LED controller 22 controls an LED serving as a light source of infrared light projector 13.

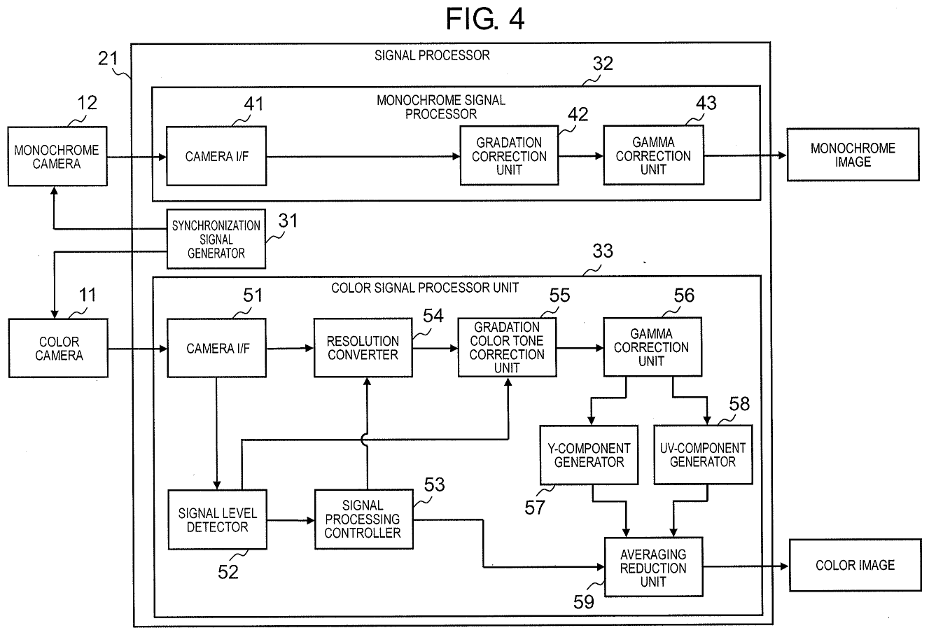

Next, signal processor 21 will be described. FIG. 4 is a functional block diagram showing a schematic configuration of signal processor 21.

Signal processor 21 includes synchronization signal generator 31, monochrome signal processor 32, and color signal processor 33.

Synchronization signal generator 31 generates a synchronization signal for synchronizing color camera 11 and monochrome camera 12. With this synchronization signal, color camera 11 and monochrome camera 12 may capture a subject at the same timing.

Monochrome signal processor 32 includes camera interface 41, gradation correction unit 42, and gamma correction unit 43.

Camera interface 41 receives an image signal of a monochrome image output from monochrome camera 12.

Gradation correction unit 42 performs a gradation correction on the image signal of the monochrome image input to camera interface 41.

Gamma correction unit 56 performs gamma correction on the image signal output from gradation correction unit 42 to correct the gradation of the image to the optimum characteristic according to the characteristic of the display device.

Color signal processor 33 includes camera interface 51, signal level detector 52, signal processing controller 53, resolution converter 54, gradation color tone correction unit 55, gamma correction unit 56, Y-component generator 57, UV-component generator 58, and averaging reduction unit 59.

Camera interface 51 receives an image signal of a color image output from color camera 11.

Signal level detector 52 detects a signal level based on the image signal of color image input to camera interface 51. This signal level represents the brightness of the entire image which is the capturing environment of the monitoring area, that is, the brightness of the environmental light of the monitoring area, and is detected based on the maximum value of luminance and the distribution status (histogram).

Signal processing controller 53 sets a degree of resolution conversion (reduction ratio) performed by resolution converter 54 with reference to the signal level acquired by signal level detector 52. Further, signal processing controller 53 sets a degree of averaging reduction (reduction ratio) performed by averaging reduction unit 59 in accordance with the degree of resolution conversion. Note that the degree of resolution conversion includes the case where the operation of resolution converter 54 is stopped and the resolution conversion is not performed, and the degree of averaging reduction includes the case where the operation of averaging reduction unit 59 is stopped and the averaging reduction is not performed. In this example, although the degree of resolution conversion (reduction ratio) performed by resolution converter 54 is set based on the signal level acquired by signal level detector 52 as the capturing environment of the monitoring area, signal level detector 52 may not be adapted, in which case a control table may be held to set the degree of resolution conversion for each nighttime zone (1 or more) according to the daytime and nighttime settings established for each day.

Resolution converter 54 performs the resolution conversion on an image signal of a color image input to camera interface 51 by integrating signal values of a plurality of adjacent pixels to reduce the number of pixels.

Gradation color tone correction unit 55 performs the gradation correction and color tone correction on the image signal of the color image output from resolution converter 54. As the gradation correction, for example, a gain adjustment is performed to brighten an image. As the color tone correction, for example, white balance correction is performed to suppress the influence of the color tone of the environmental light.

Gamma correction unit 56 performs gamma correction on the image signal output from gradation color tone correction unit 55 to correct the gradation of the image to the optimum characteristic according to the characteristic of the display device.

Y-component generator 57 generates an image signal of the Y-component (luminance signal) from the image signal output from gamma correction unit 56. UV-component generator 58 generates image signals (color difference signals) of U-component and V-component from the image signal output from gamma correction unit 56.

Averaging reduction unit 59 performs processing of reducing the color image to a predetermined size by averaging signal values of a predetermined number of pixels with respect to the image signals output from Y-component generator 57 and UV-component generator 58, respectively.

Next, the resolution conversion performed by resolution converter 54 will be described.

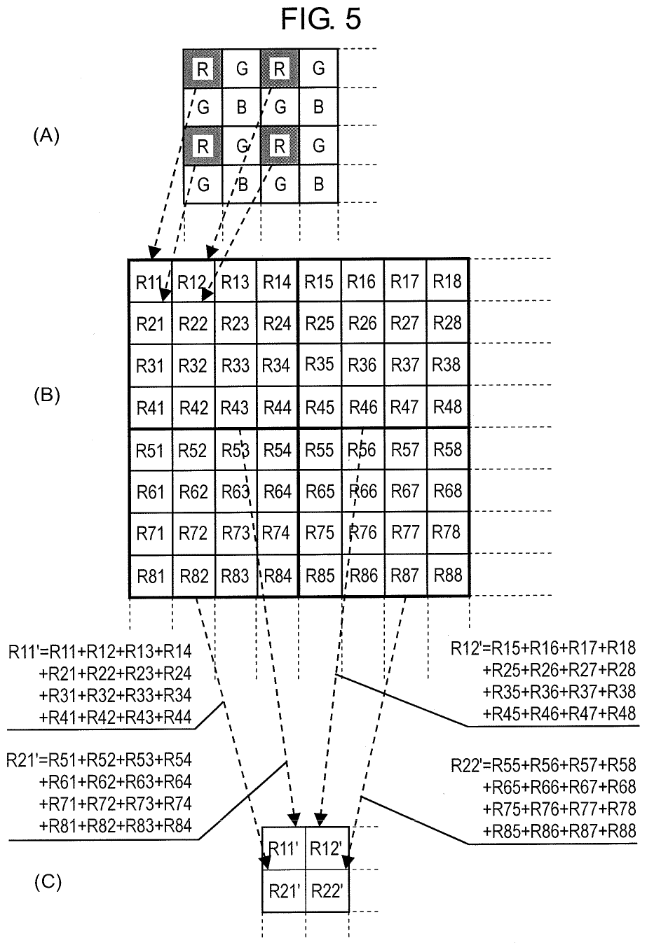

FIG. 5 is an explanatory view showing the outline of the resolution conversion.

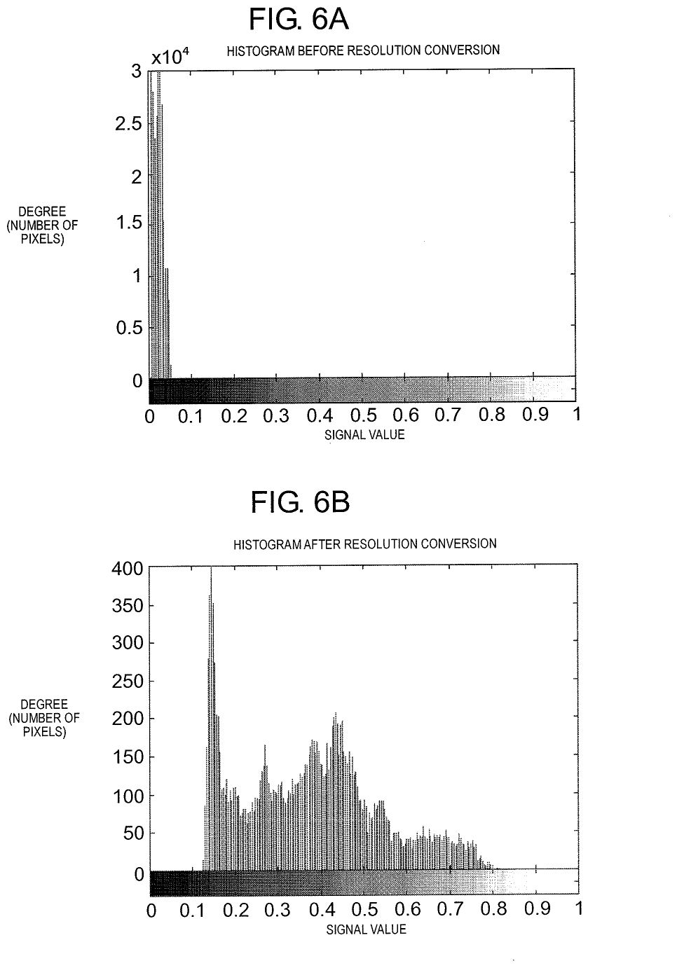

FIGS. 6A and 6B are explanatory views showing histograms before and after the resolution conversion.

In the capturing element of color camera 11, as shown in FIG. 5A, pixels of each color of R, B and G are arranged in a Bayer pattern.

As shown in FIG. 5B, resolution converter 54 adds the signal values of a predetermined number of adjacent pixels with respect to the pixels of the same color, and uses the sum total value as a signal value of one pixel as shown in FIG. 5C.

In the example shown in FIG. 5, the signal values of a total of 16 pixels of 4×4 are added. This increases the capturing sensitivity by 16 times. In addition, the resolution is lowered to 1/16, and an amount of data is reduced to 1/16.

Note that, although FIG. 5 shows about R, this equally applies to B and G.

By performing such resolution conversion, compared to the signal values that are biased to a dark range before the resolution conversion as shown in FIG. 6A, the signal values are spread over a wide range after the resolution conversion as shown in FIG. 6B.

As described above, in the exemplary embodiment, the resolution conversion is performed to reduce the number of pixels of a color image by adding signal values of a plurality of pixels. As a result, in a status in which there is slight environmental light due to streetlights, lighting of buildings, and the like, the actual color information of the subject is included in the signal value of each pixel, and therefore it is possible to output a color image in which the actual colors of the subject are clearly expressed, by adding the signal values of a plurality of pixels. In particular, it is easy to identify moving subjects in which, for example, the colors of clothes are expressed clearly in the case of a person, and the colors of a vehicle object are expressed clearly in the case of a vehicle, so that false recognition of a moving object may be avoided.

Meanwhile, since the color image generated by camera device 1 is transmitted to server device 2 through the network, it is desirable to reduce an amount of the data of the color image for the purpose of reducing the communication load.

Here, it is conceivable to perform compression processing such as JPEG, but when compression processing is performed on a color image captured in a state of insufficient environmental light, such as nighttime, the compression noise, which does not occur in the color image captured in a state of sufficient environmental light such as daytime, is noticeable and the image quality is greatly lowered.

On the other hand, in the exemplary embodiment, by performing the resolution conversion, the number of pixels of a color image is reduced, so the amount of data of the color image may be reduced. Further, the compression processing may be further performed on the resolution-converted color image, and in this case, the compression noise may be significantly reduced as compared to the case in which the compression processing is performed without performing the resolution conversion.

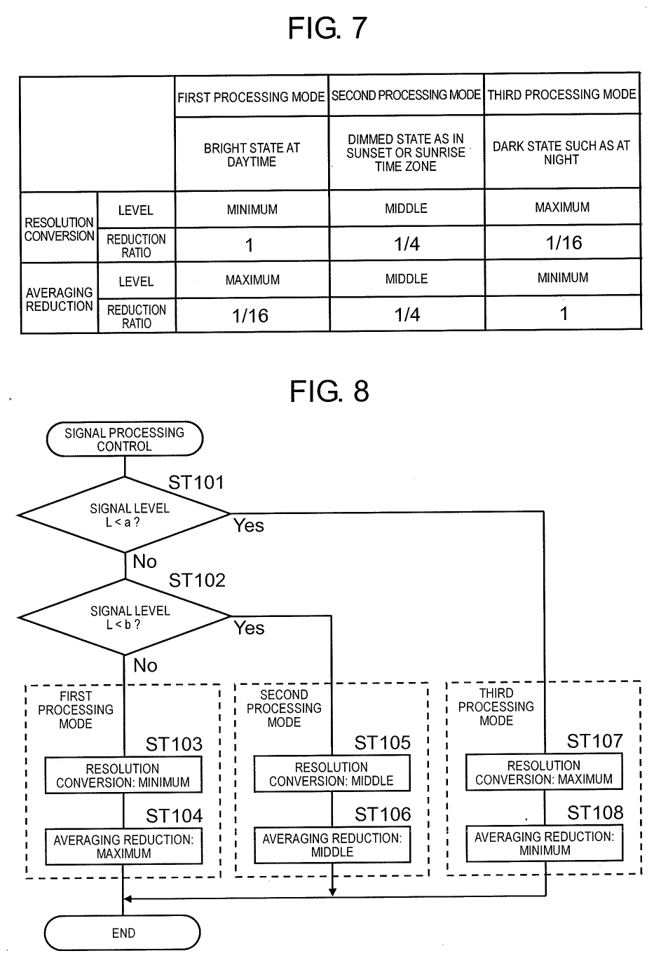

Next, the processing performed by signal processing controller 53 will be described. FIG. 7 is an explanatory view showing a processing mode set by signal processing controller 53. FIG. 8 is a flowchart showing the procedure of processing performed by signal processing controller 53.

Signal processing controller 53 compares the signal level acquired by signal level detector 52 with a plurality of threshold values, and changes the degree of resolution conversion to be performed by resolution converter 54 in steps based on the comparison result.

In the example shown in FIG. 7, three levels (minimum, middle, maximum) are set as the degree of resolution conversion, which are divided for three processing modes based on the signal level. Thereby, appropriate resolution conversion may be performed so that the signal value of each pixel is not saturated.

The first processing mode is performed in a bright state at daytime. In this first processing mode, the level of resolution conversion is minimum, and the reduction ratio of resolution conversion is 1, that is, the resolution conversion is not performed.

The second processing mode is performed in a dimmed state as in the sunset or sunrise time zone. In this second processing mode, the level of resolution conversion is middle, and the reduction ratio of resolution conversion is ¼. That is, by adding the signal values of a total of four pixels of 2×2, the resolution conversion is performed to set the resolution to ¼.

The third processing mode is implemented in a dark state such as at night. In this third processing mode, the level of resolution conversion is maximum, and the reduction ratio of resolution conversion is 1/16. That is, by adding the signal values of a total of 16 pixels of 4×4, the resolution conversion is performed to set the resolution to 1/16.

Further, signal processing controller 53 sets the degree of averaging reduction performed by averaging reduction unit 59 in accordance with the degree of resolution conversion in order to finally obtain a color image of the same size regardless of the degree of resolution conversion performed by resolution converter 54.

That is, when the reduction ratio of resolution conversion in the first processing mode is 1, the level of averaging reduction is maximum, and the reduction ratio of averaging reduction is set to 1/16. When the reduction ratio of resolution conversion in the second processing mode is ¼, the level of averaging reduction is middle, and the reduction ratio of averaging reduction is set to ¼. When the reduction ratio of resolution conversion in the third processing mode is 1/16, the level of averaging reduction is minimum, and the reduction ratio of averaging reduction is set to 1. That is, the averaging reduction is not performed. As a result, a color image reduced to 1/16 is obtained in all processing modes.

Specifically, as shown in FIG. 8, the signal level L acquired by signal level detector 52 is compared with the two threshold values a and b (a<b) to determine whether or not the signal level L is less than the threshold value a (ST101), and whether the signal level L is less than the threshold value b (ST102). Thus, the levels of resolution conversion and averaging reduction are determined in the three processing modes.

That is, when the signal level L is equal to or greater than the threshold value b (No in ST102), that is, when in bright state such as daytime, the first processing mode is set, and accordingly, the level of resolution conversion is set to minimum (ST103) and the level of averaging reduction is set to the maximum (ST104).

In addition, when the signal level L is equal to or greater than the threshold value a and less than the threshold value b (Yes in ST102), that is, when in a dimmed state as in the sunset or sunrise time zone, the second processing mode is set, and accordingly, the level of resolution conversion is set to the middle (ST105) and the level of averaging reduction is set to the middle (ST106).

Further, when the signal level L is less than the threshold value a (Yes in ST101), that is, when in a dark state such as at night, the third processing mode is set, and accordingly, the level of resolution conversion is set to the maximum (ST107) and the level of averaging reduction is set to the minimum (ST108).

In the examples shown in FIGS. 7 and 8, there are three cases (first to third processing modes) divided in accordance with the signal level, but there may be two divided cases or four or more divided cases. In addition, although the reduction ratio of resolution conversion is set to 1, ¼, and 1/16, it is possible to perform the resolution conversion with various reduction ratio by adding the signal values of a total of 64 pixels of 8×8 to perform the resolution conversion at a resolution of 1/16, and the like.

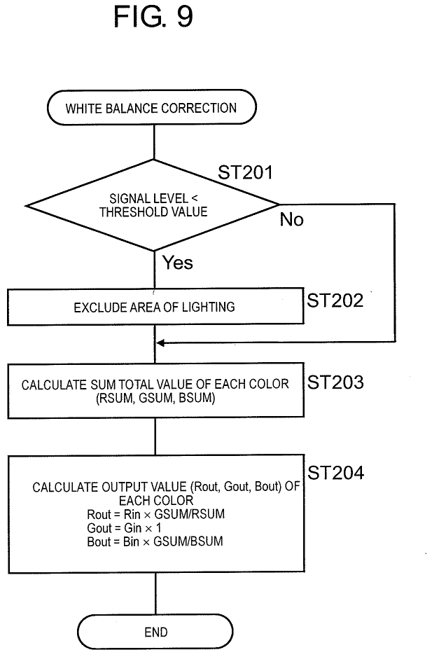

Next, white balance correction performed by gradation color tone correction unit 55 will be described. FIG. 9 is a flow chart showing the procedure of white balance correction.

Gradation color tone correction unit 55 performs white balance correction on the image signal of the color image output from resolution converter 54. The white balance correction corrects the color tone, while regarding the brightest (high-luminance) area as white. Therefore, in an image in which a night lighting, for example, a street lamp or a headlight of a vehicle is shown, the area of the lighting is the brightest, so this area is regarded as white and the color tone is corrected. At this time, when the light of the lighting is not white, a color fogging is generated in which the color of the image is generally deviated.

Therefore, in the exemplary embodiment, the white balance correction is performed excluding the area of the lighting.

Specifically, first, it is determined whether or not the signal level acquired by signal level detector 52 is less than a predetermined threshold value (ST201). This threshold value is to identify nighttime and daytime.

Here, when the signal level is less than the threshold value (Yes in ST201), that is, when it is night, the area of the lighting in the color image is detected, and the pixels included in the area of the lighting are excluded from aggregation targets (ST202).

Next, the signal value of each pixel to be aggregated is added for each color of RGB, and the sum total value (RSUM, GSUM, BSUM) of each color is calculated (ST203). Then, the input value (Rin, Gin, Bin) of each color is multiplied by the gain of each color based on the sum total value of each color to calculate the output value (Rout, Gout, Bout) of each color (ST204). At this time, correction based on G is performed.

On the other hand, when the signal level is equal to or greater than the threshold value (No in ST201), that is, when it is daytime, the sum total value of each color is calculated with all pixels in the color image as aggregation targets (ST203) and the output value of each color is calculated (ST204).

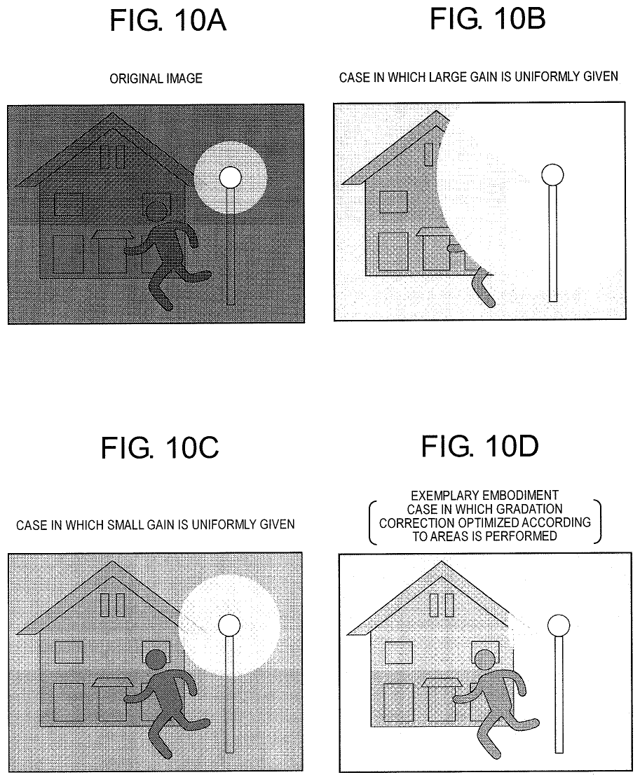

Next, gradation correction performed by gradation color tone correction unit 55 will be described. FIGS. 10A to 10D are explanatory views showing a status of gradation correction performed by gradation color tone correction unit 55.

Gradation color tone correction unit 55 adds a gain to the image signal of the color image output from resolution converter 54 to perform the gradation correction (gain adjustment) to brighten the color image.

The example shown in FIGS. 10A to 10D is a nighttime color image in which the light of a street lighting is shown, and as shown in FIG. 10A, the original image is dark as a whole, and it is difficult to see the subject.

Here, when a large gain is uniformly applied to the image signal of the original image, the entire image is bright and the subject may be easily seen in an area away from the lighting as shown in FIG. 10B, but with halation being noticeable, it is difficult to see the subject in the area in the vicinity of the lighting.

On the other hand, when a small gain is uniformly applied to the image signal of the original image, as shown in FIG. 10C, the halation is reduced, but the entire image is only slightly brightened, and the state in which the subject is difficult to see is not much improved.

Therefore, in the exemplary embodiment, gradation correction optimized according to areas is performed. That is, a large gain is given to the dark area away from the lighting, and a small gain is given to the bright area in the vicinity of the lighting.

As a result, as shown in FIG. 10D, the subject in the area away from the lighting is easy to see, and the halation is reduced so that the subject in the area in the vicinity of the lighting is also easy to see. As described above, by providing different gains according to the areas, it is possible to acquire an optimal image that is not affected by halation.

As described above, the exemplary embodiment has been described as an example of the technique disclosed in the present application. However, the technology in the present disclosure is not limited to this, and may also be applied to exemplary embodiments in which changes, replacements, additions, deletions, and the like are applied. In addition, it is also possible to combine each component described in the exemplary embodiment described above to form a new exemplary embodiment.

For example, in the exemplary embodiment described above, an example in which the moving object to be monitored is mainly a person is described, but the moving object to be monitored is not limited to a person, and may be an animal or a vehicle.

In the exemplary embodiment described above, while the control is performed based on the signal level representing the brightness of the environmental light, the control based on time information may be performed since the brightness of the environmental light changes regularly with changes. of the sunshine hours according to the season or time. However, since the brightness of the environmental light changes according to weather, the control based on the signal level may provide the control with higher accuracy.

In the exemplary embodiment described above, various image processing (signal processing) such as resolution conversion is performed at the camera device, but all or some of these image processing may be performed in the server device. However, because the resolution conversion and the averaging reduction processings reduce the communication load by reducing an amount of data of the image, it is desirable that these processings are performed at the camera device.

Furthermore, in the exemplary embodiment described above, the processed color image and monochrome image are output from the camera device, but the color image and the monochrome image captured at night may be synthesized to perform image synthesization to generate a synthesized image. Note that this image synthesization may be performed by either the camera device or the server device.

In the image synthesization, for example, processing of acquiring color information from a color image and coloring the monochrome image using the color information is performed. In the exemplary embodiment, a color image in which the actual colors of the subject are clearly expressed is acquired by the resolution conversion, and color information of a moving object appearing at night may be accurately acquired from this color image. In addition, a high definition monochrome image may be acquired by capturing using near infrared light, and a nighttime color image in which the color of the moving object is faithfully reproduced with high definition may be generated by coloring the monochrome image using color information acquired from the color image.

### INDUSTRIAL APPLICABILITY

The moving object monitoring device and the moving object monitoring system in accordance with the disclosure have an effect of being able to output, with a low-cost configuration, a suitable color image in which the actual colors of a capturing subject are clearly expressed in accordance with the status of environmental light and are useful as a moving object monitoring device that outputs an image obtained by capturing a monitoring area where a moving object to be monitored appears, and a moving object monitoring system that transmits the image obtained by capturing the monitoring area from the moving object monitoring device to an image storage device through a network.

### REFERENCE MARKS IN THE DRAWINGS

1 CAMERA DEVICE (MOVING OBJECT MONITORING DEVICE)

2 SERVER DEVICE (IMAGE STORAGE DEVICE)

11 COLOR CAMERA

12 MONOCHROME CAMERA

14 COMMUNICATION UNIT

15 CONTROLLER

21 SIGNAL PROCESSOR

52 SIGNAL LEVEL DETECTOR

53 SIGNAL PROCESSING CONTROLLER

54 RESOLUTION CONVERTER

59 AVERAGING REDUCTION UNIT

1. A moving object monitoring device that outputs a color image and a monochrome image obtained by capturing a monitoring area where a moving object to be monitored appears, the moving object monitoring device comprising:
a color camera that captures the monitoring area using environmental light;
a monochrome camera that captures the monitoring area using infrared light; and
a signal processor that processes a signal of a color image output from the color camera and a signal of a monochrome image output from the monochrome camera,
wherein the signal processor includes
a resolution converter that reduces the number of pixels in the color image by adding a signal value of each of a plurality of adjacent pixels in the color image, and
a signal processing controller that controls an operation of the resolution converter based on a capturing environment of the monitoring area.

2. The moving object monitoring device of claim 1, further comprising:
a signal level detector that detects a signal level of the color image,
wherein for determining the capturing environment, the signal level is referred to.

3. The moving object monitoring device of claim 1,
wherein the signal processing controller stops the operation of the resolution converter when it is determined that the signal level is equal to or greater than a predetermined threshold value.

4. The moving object monitoring device of claim 1,
wherein the signal processing controller compares the signal level with a plurality of threshold values, and changes a degree of resolution conversion at the resolution converter stepwise based on the comparison result.

5. The moving object monitoring device of claim 1, further comprising:
an averaging reduction unit that performs reduction processing by averaging on the signal of the color image output from the resolution converter,
wherein the signal processing controller sets a degree of averaging reduction at the averaging reduction unit so that the color image of a same size is obtained according to a degree of resolution conversion at the resolution converter.

6. A moving object monitoring system that transmits a color image and a monochrome image obtained by capturing, at a moving object monitoring device, a monitoring area where a moving object to be monitored appears, from the moving object monitoring device to an image storage device through a network,
wherein the moving object monitoring device includes
a color camera that captures the monitoring area using environmental light,
a monochrome camera that captures the monitoring area using infrared light,
a signal processor that processes a signal of a color image output from the color camera and a signal of a monochrome image output from the monochrome camera, and
a communication unit that transmits the color image and the monochrome image processed by the signal processor to the image storage device, and
the signal processor includes
a resolution converter that reduces a number of pixels in the color image by adding a signal value of each of a plurality of adjacent pixels in the color image, and
a signal processing controller that controls an operation of the resolution converter based on a capturing environment of the monitoring area.

7. The moving object monitoring system of claim 6,
wherein the communication unit adds capturing information including at least one of an installation location, a camera attribute, a capturing time, and a capturing condition to the color image and the monochrome image and transmits the color image and the monochrome image
